(19) United States
(12) Patent Application Publication
(10) Pub. No.: US 2023/0238547 A1
(43) Pub. Date: Jul. 27, 2023

(54) METHOD FOR PRODUCING A BIPOLAR PLATE, AND FUEL CELL

(71) Applicant: Robert Bosch GmbH, Stuttgart (DE)

(72) Inventor: Philipp Krueger, Hoepfigheim (DE)

(21) Appl. No.: 18/011,324

(22) PCT Filed: May 11, 2021
(86) PCT No.: PCT/EP2021/062467

§ 371 Date: Dec. 19, 2022

(30) Foreign Application Priority Data
Jun. 19, 2020 (DE) 10 2020 207 603.0

(51) Int. Cl. H01M 8/0247; H01M 8/0206; B23K 26/244; B23K 26/70

(52) U.S. Cl. CPC H01M 8/0247; H01M 8/0206; B23K 26/244; B23K 26/70; B23K 2101/18

(57) ABSTRACT

The invention relates to a method for producing a bipolar plate (5), comprising the following steps: a. providing two planar components (7), which are present in particular in a stacked manner, b. integrally bonding the two planar components (7), in particular by welding, in a joining plane (34), wherein, prior to integrally bonding, internal stresses (9) are introduced into at least one of the two planar components (7). The invention also relates to a fuel cell (1) comprising a bipolar plate (5) produced according to this method.

### BACKGROUND OF THE INVENTION

The invention relates to a method for producing a bipolar plate, comprising the steps of providing two planar components and integrally bonding the two planar components. The invention also relates to a fuel cell comprising a bipolar plate.

A fuel cell is an electrochemical cell that converts the chemical reaction energy of a continuously supplied fuel and an oxidizing agent into electrical energy. A fuel cell is thus an electrochemical energy converter. In known fuel cells, hydrogen (H₂) and oxygen (O₂) are in particular converted to water (H₂O), electrical energy, and heat.

Among others, proton-exchange membrane (PEM) fuel cells are known. Proton-exchange membrane fuel cells comprise a centrally arranged membrane that is permeable to protons, i.e., hydrogen ions. The oxidizing agent, in particular atmospheric oxygen, is thereby spatially separated from the fuel, in particular hydrogen.

Furthermore, solid oxide fuel cells (SOFC) are known. SOFC fuel cells have a higher operating temperature and exhaust temperature than PEM fuel cells and are in particular used in stationary operation.

Fuel cells comprise an anode and a cathode. The fuel is supplied to the fuel cell at the anode and catalytically oxidized with loss of electrons to form protons that reach the cathode. The lost electrons are discharged from the fuel cell and flow via an external circuit to the cathode.

The oxidizing agent, in particular atmospheric oxygen, is supplied to the fuel cell at the cathode and reacts to form water by receiving the electrons from the external circuit and protons. The resulting water is drained from the fuel cell. The gross reaction is:

O₂+4H⁺+4e⁻→2H₂O

A voltage is applied between the anode and the cathode of the fuel cell. In order to increase the voltage, a plurality of fuel cells may be mechanically arranged one behind the other to form a fuel cell stack and may be electrically connected in series.

A fuel cell stack usually comprises end plates that press the individual fuel cells together and provide stability to the fuel cell stack. The end plates also serve as a positive or negative pole of the fuel cell stack for discharging the current.

The electrodes, i.e., the anode and the cathode, and the membrane may be structurally assembled to form a membrane-electrode assembly (MEA).

Fuel cell stacks furthermore comprise bipolar plates, also referred to as gas diffuser plates. Bipolar plates serve to distribute the fuel evenly to the anode and to distribute the oxidizing agent evenly to the cathode. Furthermore, bipolar plates usually have a surface structure, for example channel-like structures, for distributing the fuel and the oxidizing agent to the electrodes. The channel-like structures also serve to drain the water produced during the reaction. In addition, the bipolar plates may comprise structures for passing a cooling medium through the fuel cell in order to dissipate heat.

In addition to the media guidance with respect to oxygen, hydrogen, and water, the bipolar plates ensure a planar electrical contact to the membrane.

A fuel cell stack typically comprises up to a few hundred individual fuel cells stacked one on top of the other in layers as so-called sandwiches. The individual fuel cells comprise one MEA as well as one bipolar plate half each on the anode side and on the cathode side. In particular, a fuel cell comprises an anode monopolar plate and a cathode monopolar plate, which are merged and form a bipolar plate.

In order to produce bipolar plates that separate hydrogen, air, and, where applicable, the cooling medium, for example water, from one another, steel sheets are usually integrally bonded to one another by, for example, laser beam welding. In order to minimize component distortion during laser beam welding, the process parameters are selected such that as little energy as possible is input, wherein narrow weld seams with a low weld pool volume are produced.

Due to the low weld pool volume and the high process speeds required as a result, the ability to bridge gaps in laser beam welding is low so that too large a gap between the anode sheet and cathode sheet can lead to defects in the weld seam and thus to leakages in the bipolar plate and hence in the fuel cell.

In order to produce bipolar plates, thin sheets of a low stiffness are usually used and, due to the heat input of the welding process and the resulting local component distortion, the sheets to be bonded form a gap leading the actual welding process. This gap cannot be kept sufficiently narrow by clamping the sheets to be connected parallel to the weld seam, in order to avoid defects.

DE 10 2016 200 387 A1 describes an apparatus and a method for producing a bipolar plate, wherein two separator plates are connected to one another. The separator plates lie on top of one another and are, for example, seal-welded in a lap joint by laser. Energy for integrally bonding the two separator plates is supplied in each case via the two outer sides of the two separator plates.

### SUMMARY OF THE INVENTION

Proposed is a method for producing a bipolar plate, comprising the following steps:
a. providing two planar components, which are present in particular in a stacked manner,
b. integrally bonding the two planar components, in particular by welding, in a joining plane, wherein, prior to integrally bonding, internal stresses are introduced into at least one of the two planar components.

The two planar components are prepared for integrally bonding by introducing the internal stresses in at least one, preferably both, of the two planar components before stresses caused by the actual integral bonding occur. The internal stresses introduced are selectively introduced, are stable over time, and do not cause any material displacement and/or deformation without external influence. In particular, the position and size of the internal stresses are adjustable. The internal stresses are introduced in particular in the direct vicinity of the connecting seam to be produced. The stresses caused by the actual integral bonding can be at least partially compensated directly by the counteracting internal stresses introduced.

The welding is carried out in particular by laser beam welding. Preferably, a seam, which can also be referred to as a connecting seam, is formed by integrally bonding and has a width of preferably not more than 0.1 mm.

Stresses caused by the actual integral bonding, i.e., in particular by the laser used for integrally bonding, comprise welding distortions, for example by thermal expansion, plastic strain, and material transport during integrally bonding. Stresses caused by the actual integral bonding are present only temporarily, in particular during heating of the two planar components and in particular locally, and cannot be avoided for process-related reasons. They are usually undesirable and develop as a result of thermal expansion, a resulting compression of the material of the two planar components, a material displacement or a melt flow, and/or shrinkage that begins after solidification.

Stresses caused by the actual integral bonding are in particular compressive stresses occurring before a weld seam when heating the two planar components and tensile stresses occurring after the process of the actual integral bonding when cooling the two planar components. The direction of the strains and of the resulting distortions depends on the heat source, the seam geometry, the time, and the position on the component.

The internal stresses introduced according to the invention prior to integrally bonding are opposite to the stresses caused by the actual integral bonding. Preferably, the internal stresses introduced prior to integrally bonding are present, in particular locally, at a gap between the two planar components on which the seam is to be produced. The internal stresses are further preferably arranged laterally in the area of the seam and vertically over a thickness of the two planar components.

The internal stresses, which are thus already present, prior to integrally bonding, in at least one of the two planar components, are preferably mechanically introduced. Further preferably, the internal stresses are introduced by embossing, rolling, spinning, and/or hot embossing.

Preferably, at least one of the two planar components is deformed toward the joining plane during integrally bonding. Further preferably, at least one of the two planar components is deformed toward the joining plane by releasing the previously introduced internal stresses. A yield strength or a maximum stress, which may be present in the two planar components, is reduced with increasing temperature for metallic materials. The energy introduced by integrally bonding thus temporarily reduces the yield strength, which is understood as the stress that can be absorbed up to plastic deformation. For example, in a molten state of the material of the two planar components, the yield strength is reduced to close to zero. Thus, an equilibrium between previously introduced internal stresses is then eliminated and deformation of the two planar components takes place.

Tensile stresses and/or compressive stresses may be introduced as internal stresses. Tensile stresses and compressive stresses are preferably arranged such that a local reduction of the strength of the two planar components triggered by the temperature input of integrally bonding reduces the internal stresses introduced previously, and remaining stresses not influenced by the temperature input lead to a component distortion toward the joining plane. The tensile stresses and/or compressive stresses are preferably equalized in order to obtain a steady state.

Preferably, tensile stresses are introduced into at least one of the two planar components prior to integrally bonding. In particular, the introduced tensile stresses at least partially compensate the leading compressive stresses caused by the actual integral bonding.

Preferably, in particular in addition to or in support of the, in particular mechanical, introduction of the internal stresses prior to integrally bonding, at least one temperature field is introduced into at least one of the two planar components. The introduction of at least one temperature field comprises in particular the heating of at least one of the two planar components. In particular, one or more temperature fields are used in the seam area in order to further compensate welding-related strains. The at least one temperature field can take place, for example, by beamforming a welding laser or by using an additional laser, in particular by laser spots.

Preferably, when integrally bonding, a part of at least one of the two planar components is moved toward the joining plane. This effect is in particular due to the geometry and thermal expansion of the two planar components since material that is heated expands in all spatial directions. In order to produce a steering effect, a material portion toward the desired distortion direction is in particular increased. In particular, the part of at least one of the two planar components, which is further preferably arranged at the seam, is designed such that the leading compressive stresses, which are caused by the actual integral bonding, or an expansion of the two planar components result in a movement directed into the joining plane.

Preferably, at least one of the two planar components comprises geometry elements having a directional component which is perpendicular to a surface of the respective planar component and may also be formed during integrally bonding by the movement described above. Perpendicular in this context is to be understood in that the geometry elements have a directional component, in particular a surface and/or longitudinal axis, that encloses, with the surface of the respective planar component, an angle in a range of 60° to 120°, preferably 70° to 110°, further preferably 80° to 100°, for example 90°.

The movement toward the joining plane can also be realized by a geometry-related reduction in stiffness in the respective planar component toward the component distortion. The respective planar component in particular has a reduced stiffness, perpendicular to a component plane, i.e., perpendicular to the surface of the component. By shaping the planar component into a groove shape, for example, the stiffness of the planar component can be reduced near the seam of the joining plane. The planar component expands as a result of the temperature input in the component plane so that a lever action of possibly non-thermally influenced groove flanks can create a movement component toward the joining plane.

Preferably, the two planar components comprise a metallic material. Further preferably, the two planar components are sheets, more preferably steel sheets, in particular an anode sheet or a cathode sheet in each case. Furthermore, the two planar components preferably each have a thickness of not more than 0.1 mm.

The invention furthermore relates to a fuel cell comprising a bipolar plate produced according to the method according to the invention.

By the method according to the invention, a distortion of the components to be connected is directed and limited when integrally bonding, so that the development of a process-relatedly enlarged gap between the components to be connected is prevented or reduced. Moreover, enlarged gaps in the joining plane caused by component tolerances or impurities can also be prevented or reduced or overcome.

Accordingly, the process of integrally bonding can be stabilized and functionally relevant defects in the produced connection that lead to leakages in the fuel cell can be reduced or avoided.

Moreover, resulting internal welding stresses and a resulting end distortion of a bipolar plate that is integrally bonded can be reduced.

Furthermore, higher process speeds may be realized, or a cycle time may be reduced, and there is greater freedom in designing holding-down devices used in the process, so that the service life of the holding-down devices is increased and/or fewer cleaning operations are required.

Due to the process conditions of integrally bonding, stresses caused by the actual integral bonding in the component are unavoidable but are selectively steered or counteracted with the method according to the invention.

### BRIEF DESCRIPTION OF THE DRAWINGS

Embodiments of the invention are explained in more detail with reference to the drawings and the following description.

Shown are:

FIG. 1 a fuel cell stack,

FIG. 2 a cross-section of a fuel cell,

FIG. 3 a first connecting seam,

FIG. 4 a second connecting seam,

FIG. 5 a plan view of a connecting seam,

FIG. 6 a schematic cross-sectional view of a connecting seam during heating,

FIG. 7 a schematic cross-sectional view of a connecting seam during cooling,

FIG. 8 a schematic diagram of integrally bonding two planar components with previously introduced internal stresses,

FIG. 9 a schematic diagram of integrally bonding with additionally introduced temperature fields, and

FIG. 10 a schematic diagram of integrally bonding with geometry adjustment.

### DETAILED DESCRIPTION

In the following description of the embodiments of the invention, identical or similar elements are denoted by identical reference signs, wherein a repeated description of these elements is dispensed with in individual cases. The figures show the subject matter of the invention only schematically.

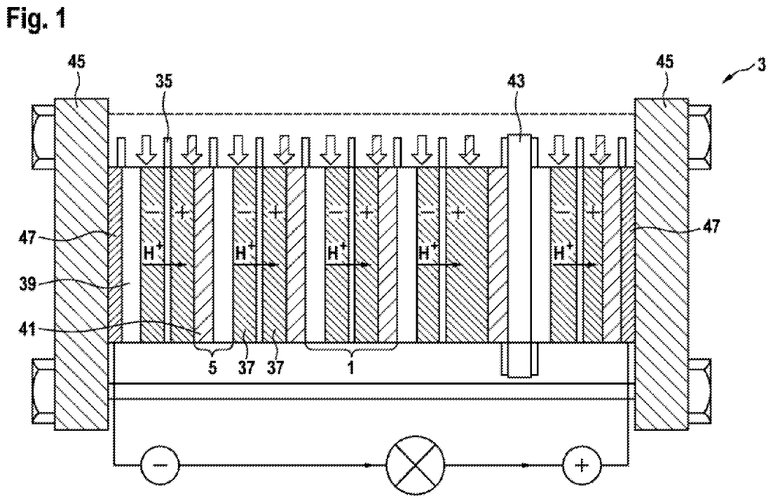

FIG. 1 shows a schematic diagram of a fuel cell stack 3 comprising a plurality of fuel cells 1. Each fuel cell 1 comprises a membrane 35, two gas diffusion layers 37, an anode 39, and a cathode 41. The individual fuel cells 1 are delimited from one another by bipolar plates 5, which may comprise a cooling plate 43. The fuel cell stack 3, to which hydrogen and oxygen as well as a cooling medium are supplied, is terminated by two end plates 45 and comprises current collectors 47.

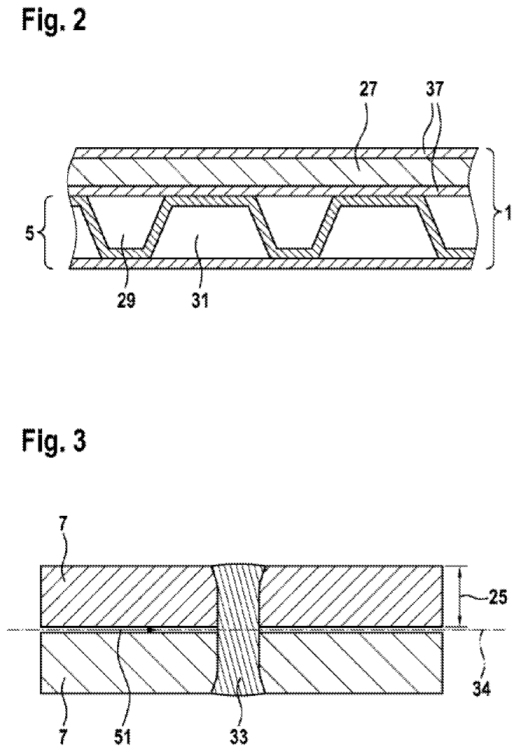

FIG. 2 shows a cross-section of a fuel cell 1. The fuel cell 1 comprises a bipolar plate 5 on which a membrane electrode unit 27 is arranged, which is located between two gas diffusion layers 37. For cooling, hydrogen 29 and water 31 are inter alia guided separately from one another in the bipolar plate 5.

FIG. 3 shows a cross-sectional view of a first connecting seam 33 in the form of a weld seam. Two planar components 7 are connected in a joining plane 34 to the connecting seam 33. Between the two planar components 7, a medium 51 to be sealed flows. The connecting seam 33 shown here is designed to be flawless so that no medium 51 escapes.

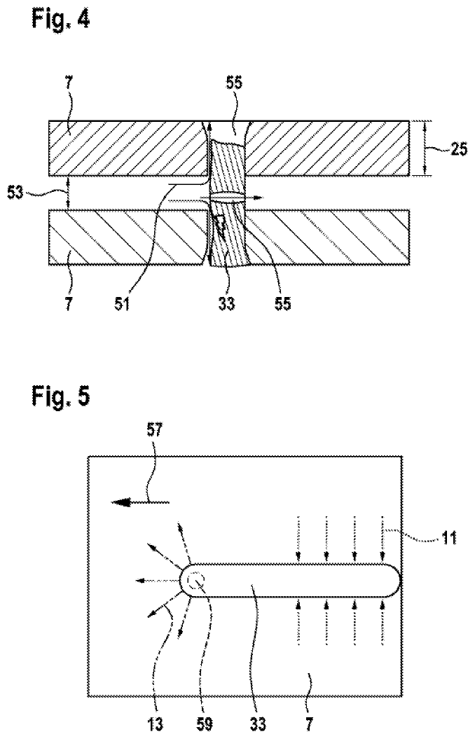

FIG. 4 shows a second connecting seam 33. In this illustration, the connecting seam 33 has defects 55 through which the medium 51 can escape. Between the planar components 7, there is a gap 53, which is not sufficiently bridged by the connecting seam 33. The defects 55 may occur as a seam collapse, ejection, seam interruption, or cracks in a bipolar plate 5, or as pores or connection interruptions between bipolar plates 5.

FIG. 5 shows a plan view of a connecting seam 33, which is carried out in a feeding direction 57. To this end, a laser beam 59 is moved in the feeding direction 57, wherein the planar component 7 is heated near the connecting seam 33, thereby causing stresses and a distortion in the planar component 7.

Heating takes place at the laser beam 59, wherein compressive stresses 13 occur. After passing through the laser beam 59, the planar component 7 cools down again so that tensile stresses 11 directed toward the connecting seam 33 occur.

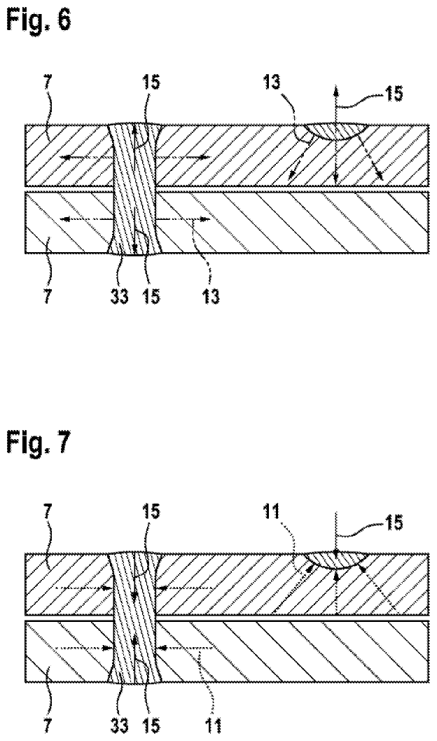

FIG. 6 shows a cross-sectional view of a connecting seam 33 during heating. Compressive stresses 13 are present, which results locally in a distortion direction 15.

FIG. 7 shows a further cross-sectional view of the connecting seam 33 according to FIG. 6. However, in the illustration shown here, the connecting seam 33 is shown during cooling, wherein tensile stresses 11 are present, which result in oppositely directed distortion directions 15 in comparison to FIG. 6.

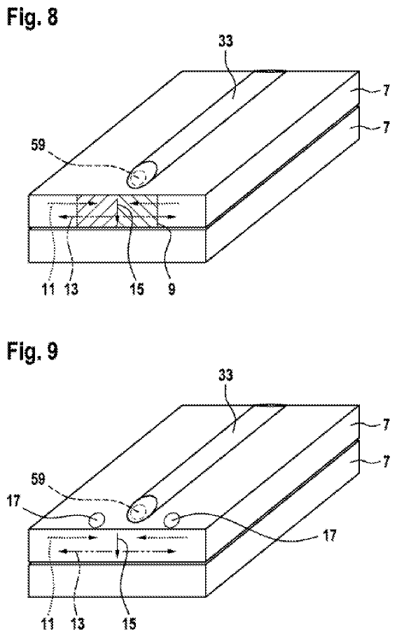

FIG. 8 shows a schematic diagram of integrally bonding, wherein two planar components 7 are connected by a connecting seam 33 by means of a laser beam 59. Prior to integrally bonding, internal stresses 9, which comprise tensile stresses 11, were introduced in a shaded region of the planar component 7. These tensile stresses compensate compressive stresses 13 leading the connecting seam 33 and in particular the laser beam 59.

FIG. 9 shows a further schematic diagram of integrally bonding, wherein temperature fields 17 were additionally introduced into the planar component 7 prior to integrally bonding.

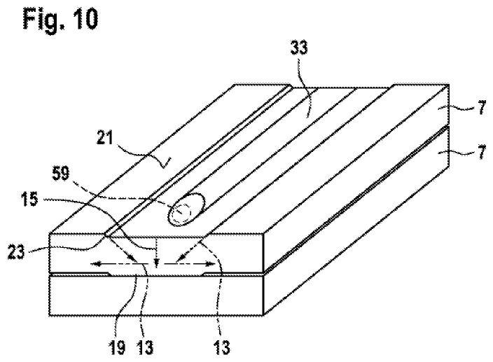

FIG. 10 shows a further schematic diagram of integrally bonding, wherein the distortion direction 15 indicates a directed weld distortion by geometry optimization in the seam area of the connecting seam 33. A surrounding area of the connecting seam 33 is designed in such a way that compressive stresses 13 leading the connecting seam 33 and thermal expansion result in a movement of a part 19 of the planar component 7 perpendicular to a surface 21 of the planar component 7 and the part 19 of the planar component 7 is deformed toward the joining plane not shown here. This is realized in the illustrated embodiment by geometry elements 23 with a direction component perpendicular to a surface 21 of the planar component 7.

The invention is not limited to the exemplary embodiments described herein and the aspects highlighted therein. Rather, a variety of modifications, which are within the scope of activities of the person skilled in the art, is possible within the range specified by the claims.

1. Method A method for producing a bipolar plate (5), comprising the following steps:
a. providing two planar components (7), and
b. integrally bonding the two planar components (7), in particular by welding, in a joining plane (34), wherein, prior to integrally bonding, internal stresses (9) are introduced into at least one of the two planar components (7).

2. The method according to claim 1, characterized in that the internal stresses (9) are mechanically introduced.

3. The method according to claim 1, characterized in that, during integrally bonding, at least one of the two planar components (7) is deformed toward the joining plane (34).

4. The method according to claim 1, characterized in that, prior to integrally bonding, tensile stresses (11) are introduced into at least one of the two planar components (7).

5. The method according to claim 1, characterized in that, prior to integrally bonding, at least one temperature field (17) is introduced into at least one of the two planar components (7).

6. The method according to claim 1, characterized in that, when integrally bonding, a part (19) of at least one of the two planar components (7) is moved toward the joining plane (34).

7. The method according to claim 1, characterized in that at least one of the two planar components (7) comprises geometry elements (23) with a direction component perpendicular to a surface (21) of the respective planar component (7).

8. The method according to claim 1, characterized in that the two planar components (7) are sheets.

9. The method according to claim 1, characterized in that the two planar components (7) each have a thickness (25) of not more than 0.1 mm.

10. A method for producing a fuel cell (1), the method comprising producing a bipolar plate (5) according to the method of claim 1.

11. A method for producing a bipolar plate (5), the method comprising the following steps:
a. providing two planar components (7) in a stacked manner,
b. introducing internal stresses (9) into at least one of the two planar components (7), and
c. thereafter integrally bonding the two planar components (7), by welding, in a joining plane (34).

12. The method according to claim 11, characterized in that the internal stresses (9) are mechanically introduced.

13. The method according to claim 12, characterized in that, during integrally bonding, at least one of the two planar components (7) is deformed toward the joining plane (34).

14. The method according to claim 13, characterized in that, prior to integrally bonding, tensile stresses (11) are introduced into at least one of the two planar components (7).

15. The method according to claim 14, characterized in that, prior to integrally bonding, at least one temperature field (17) is introduced into at least one of the two planar components (7).

16. The method according to claim 15, characterized in that, when integrally bonding, a part (19) of at least one of the two planar components (7) is moved toward the joining plane (34).

17. The method according to claim 16, characterized in that at least one of the two planar components (7) comprises geometry elements (23) with a direction component perpendicular to a surface (21) of the respective planar component (7).

18. The method according to claim 17, characterized in that the two planar components (7) are an anode sheet or a cathode sheet in each case.

19. The method according to claim 18, characterized in that the two planar components (7) each have a thickness (25) of not more than 0.1 mm.
